(19) United States
(12) Patent Application Publication
(10) Pub. No.: US 2017/0272140 A1
(43) Pub. Date: Sep. 21, 2017

(54) AUTONOMOUS ANTENNA ALIGNING SYSTEM AND METHOD

(71) Applicant: CyberTAN Technology, Inc., Hsinchu (TW)

(72) Inventors: JENN-CHORNG LIOU, Hsinchu (TW); CHUNG-HO WU, Hsinchu (TW)

(21) Appl. No.: 15/461,482

(22) Filed: Mar. 17, 2017

Related U.S. Application Data
(60) Provisional application No. 62/310,072, filed on Mar. 18, 2016.

(51) Int. Cl. H04B 7/06; H04B 7/0413; H04L 5/00

(52) U.S. Cl. CPC H04B 7/0632; H04L 5/006; H04B 7/0413

(57) ABSTRACT

A wireless apparatus with embedded data source or data sink is used to measure radio transmission quality on installation. Indicators are used to display the transmission quality and to assist the installer how to orient the antenna.

### CROSS-REFERENCE TO RELATED APPLICATIONS

This application claims priority to U.S. Patent Application No. 62/310,072 filed on Mar. 18, 2016, the contents of that are incorporated by reference herein.

### FIELD

The subject matter herein generally relates to an antenna aligning system.

### BACKGROUND

As communication technology evolves, the use of wireless communication technology has become pervasive. The demand for wireless communication technology as a transmission medium is ever increasing. No matter it is in a point-to-point architecture or in an access point (base stations) architecture with a plurality of terminal devices (such as mobile phones, laptops, personal digital assistants, internet appliances, etc.), wireless communications between individuals and groups of terminal devices are extensively being used. The use of directional antennas for wireless connections between the two end points is very common. As the wireless spectrum becomes more crowded, directional antennas are being used to avoid or mitigate interference with other wireless networks. In addition, high-gain directional antennas can also be used to overcome the distance between nodes of a wireless network, and to increase the signal to noise ratio (SNR) to improve link quality. Parabolic antennas are commonly being used in the directional communication needs. Two parabolic antennas are to align their directional radio beams with each other to establish a wireless link. When two parabolic antennas are within naked eye distance, they may be visually aligned. When the distance exceeds the naked eye capabilities, we have to turn to geometrical means such as a compass or GPS positioning to accurately rotate the antenna to establish an initial contact.

Once the initial radio contact is being established, the installer will further count on performance data such as signal strength (RSSI) or data throughput to fine tune the tilt angle and azimuth of the parabolic antenna to achieve optimal performance. In an indoor environment electromagnetic waves are susceptible to reflection or refraction of objects such as furniture, walls and floors. These create interferences, attenuation or offset due to multiple paths of the electromagnetic waves. For a pair of radio devices in an indoor environment, using visual means or turning to geographical means such as a map, a compass or GPS positioning may turn out to be futile in optimization of antenna orientation. The signal strength (RSSI) or data throughput and other performance figures will be better indicators for the installation of the antenna. For long-distance and short-range high-performance data radio network installers it is therefore very important if there is a simple method to provide indicators such as signal strength (RSSI) or data throughput and other performance figures. A rudimental way is to use an array of illuminated LED lights on the radio to indicate the signal strength (RSSI). But RSSI rather indicates the signal strength but not signal quality. The signal quality (or alternatively being referred to as “transmission quality” in this work) usually represents the composition of the signal strength, the correctness of modulation/demodulation, and the effects of interference. A good radio installation must focus on better signal quality, rather than signal strength, to achieve higher bandwidth.

If a radio installer needs to orient the antenna according to the signal quality, a series of test equipment is usually required. This is because the electronic part of the radio is usually partitioned into functional blocks such as a radio transceiver, a modulation/demodulation baseband, and data source/sink on server (information source) and client (information destination) which have the ultimate communication needs. The server and client data source/data sink is usually separated from the radio transceiver and the modulation/demodulation baseband. This is because radios are often designed to be used in a different variety of data services, not just for a single purpose. While a point-to-point microwave link is being installed, the signal quality test equipment located at two ends represents data source/data sink on the server and client. This is to simulate the actual data communication link. In radio communications, well-known signal quality testers include I-perf and Chariot for signal quality testing in which data is being continuously streamed. To measure instantaneous throughput, computers located at two ends running file transfer (FTP) can be used as a client/server data source/data sinks. The quality of data transmission can be attested by measuring the time required to transfer a complete file with a known size. For radio installers, if the data source/data sink and wireless transceiver and baseband circuit can be integrated as one, the equipment needed for antenna orientation can be much simpler. Once the antenna is being oriented to the best data transmission quality, it can be determined that the optimal transmission/receiving state has been reached.

### SUMMARY

In one aspect of the disclosure, a data source/a data sink, or the file delivery mechanism is integrated into the radio device. It is usually a piece of software being executed in the radio device. It measures and displays the signal quality of the data transmission, as the assistance toward installation. The indicator of signal quality may be integrated into the radio device itself, or can be externally displayed. As examples, indicators may be LED, LCD, display panel, or a vibrator. If a smart phone can be connected to the radio device, we can rather use the smart phone as a display interface to show the signal quality. The signal quality may be shown in numbers, figures, vibration, or sound. In case the radio devices support WI-FI, smart phones may be used as user interface to help the installer to orient of the antenna.

An exemplary embodiment of the disclosure provides the wireless transceiver device which comprises an antenna, the data source generating the data packets on the transmitting side, the data sink on the receiving side measuring the signal quality according to the data packets received from the data source, a baseband transceiver configured to transmit or receive wireless signals and the data packets, a processor with executable software that generates the data packets at the transmitting end and measures signal quality with respect to the received data packets at the receiving end, and an indicator that indicates the signal quality.

An exemplary embodiment of the disclosure provides the wireless transceiver system, which comprises a first wireless transceiver and a second wireless transceiver. The first wireless transceiver comprises a first antenna, a first processor, and a first baseband transceiver. The first processor comprises executable software that generates the data packets to be used for measuring the transmission quality. The first baseband transceiver is configured to transmit/receive wireless signal and transmit the data packets. The second wireless transceiver comprises a second antenna, a second processor, and a second baseband transceiver. The second processor comprises executable software which measures transmission quality according to the completeness of the data packets received and the time spent. The second baseband transceiver is configured to transmit/receive wireless signal and receive the data packets. The indicator may generate the indicating signal according to the signal quality.

An exemplary embodiment of the disclosure provides the antenna alignment method. The first wireless transceiver generates the data packets. The first wireless transceiver transmits the data packets through the first antenna. The second wireless transceiver receives the data packets through the second antenna. The signal quality is determined by reference to the completeness of data packets received and the time spent. The indicator signal is generated according to the signal quality.

### BRIEF DESCRIPTION OF THE DRAWINGS

Implementations of the present technology will now be described, by way of example only, with reference to the attached figures, wherein:

FIG. 1 illustrates an antenna aligning system according to an exemplary embodiment of the disclosure;

FIG. 2 illustrates a test flow chart of a forward type of transmission quality of an antenna aligning system according to an exemplary embodiment of the disclosure;

FIG. 3 illustrates the antenna aligning system according to another exemplary embodiment of the disclosure;

FIG. 4 illustrates the antenna aligning system according to another exemplary embodiment of the disclosure;

FIG. 5 illustrates a multiple antenna system according to an exemplary embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. The term “comprising,” when utilized, is “including, but not necessarily limited to”; it specifically indicates open-ended inclusion or membership in the so-described combination, group, series, and the like. References to “an” or “one” exemplary embodiment in this disclosure are not necessarily to the same exemplary embodiment, and such references mean “at least one.”

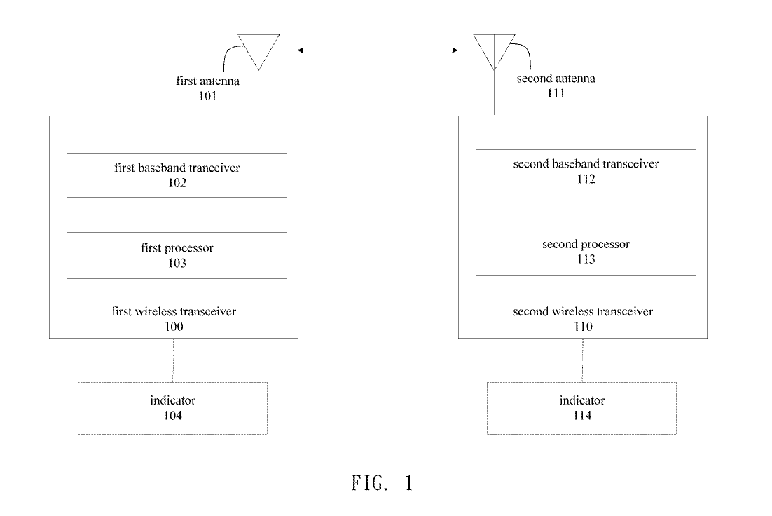

FIG. 1 shows an antenna aligning system according to an exemplary embodiment of the disclosure. As shown in FIG. 1, the antenna aligning system comprises a first wireless transceiver 100 and a second transceiver 110. The first wireless transceiver 100 comprises a first antenna 101, a first baseband transceiver 102, and a first processor 103. The first processor 103 comprises executable software that may generate data packets. The first baseband transceiver 102 transmits data packets through the first antenna 101 (via intermediate function blocks such as modulation, frequency-shifting and amplification, not shown in the FIG. 1) to the second wireless transceiver 110. The second wireless transceiver 110 comprises a second antenna 111, a second baseband transceiver 112, and a second processor 113. The second baseband transceiver 112 receives the data packets from the first wireless transceiver 100 through the second antenna 111 (via intermediate function blocks such as demodulation, frequency-shifting, and amplification, not shown in the FIG. 1). The second processor 113 comprises executable software that measures the signal quality according to the completeness of data packets received and the time spent. The first wireless transceiver 100 comprises an indicator 104 and the second wireless transceiver 110 comprises an indicator 114. Taking this antenna alignment system as an example, the indicator 114 generates indicator signals according to the quality of signal quality. The installer orients the second antenna 111 according to the indicator signals. The second baseband transceiver 112 can also transmits the signal quality data back to the first wireless transceiver 100 through the second antenna 111. The first baseband transceiver 102 receives the signal quality data through the first antenna 101. The first processor 103 comprises executable software that may receive the signal quality data sent from the second antenna 111. The indicator 104 of the first wireless transceiver 100 displays the signal quality and thereby the installer of the first wireless transceiver 100 can orients the first antenna 101 according to the indicator signals. The first antenna 101 can be oriented manually by an installer with the reference to the indicator 104, or be dynamically oriented by a motor according to the link quality data.

Strictly speaking, the above-mentioned transmission quality is based on the arrangement that the first wireless transceiver 100 transmits and the second wireless transceiver 110 receives the data packets (to be referred to as “forward” transmission quality). In general, if the designs of wireless transmission/receiving devices on two ends are of the same type, the electromagnetic wave characteristics to and from will be symmetrical and equivalent. The measurement arrangement in which the second wireless transceiver 110 transmits and the first wireless transceiver 100 receives (to be referred to as “reverse” transmission quality) will no longer be necessary. The task of antenna orientation of the two antennas 101 and 111 is therefore being completed. However, if the designs of the wireless transceivers differ in bandwidths, antenna types, modulation and demodulation mechanisms, furthermore if the forward and reverse electromagnetic waves differ in transmission, interference and reflection characteristics, the reverse transmission quality may also be of significant value and may also affect antenna orientation. The reverse transmission quality can be made available by the second wireless transceiver 110 transmitting data packets through the second antenna 111 to the first wireless transceiver 100. The first wireless transceiver 100 measures the (reverse) transmission quality and generates indicator signal based on the transmission quality to instruct the installer to adjust the first antenna 101 and in turn transmits the reverse transmission quality to the second wireless transceiver 110 to assist the installer to adjust the orientation of the second antenna 111. By repeated two-way adjustment, both forward and reverse paths are optimized for the transmission quality.

The first antenna and the second antenna can be in any type, such as single polarized antenna, dipole antenna, loop antenna, slot antenna, microstrip antenna, and dish antenna, etc. Most antennas being used in long distance communication are directional. It is common that in doing installation, the installer will gradually adjust the antenna orientations toward the highest gain (the peak). In complicated installation environments, there can be reflection, interference and other factors, so that the peak in antenna gain may not necessarily be the orientation for optimal transmission quality and the best throughput. The indicator in this work is created according to the transmission quality, rather than peak gain, thus providing the installer with the most valuable assistance. The antenna can also be non-stationary. In this case dynamically orienting the antenna by using the motor would be more appropriate.

There are two different approaches for testing signal quality. The first approach is using a fixed-sized data file. Some packets may be lost during radio waves transmission in the air because of the interference by noise. Modern chipset solutions include algorithms to retransmit the packets if they get lost, at the expense of spending more time in receiving the complete set of packets. In this case signal quality (in terms of Mbps) is being measured by transmitting rate and the time spent to receive the complete set of packets in that fixed-sized data file. The other approach is to transmit a continuous, fixed-rate data stream. Because of the interference by noise, some packets will be lost. Modern chipset solutions include algorithms to retransmit which reduce the effectiveness of the data flow if the interference is severe. In this case the signal quality is being calculated by successful data being received per unit time.

The indicator may be any kind of indicator for human sense, such as the display embedded in the wireless transceiver, the light indication by an array of LEDs, the frequency of a mechanical vibration, volume or pitch of a buzzer, or an application installed on a smart phone to provide a graphical display (such as a rotating needle).

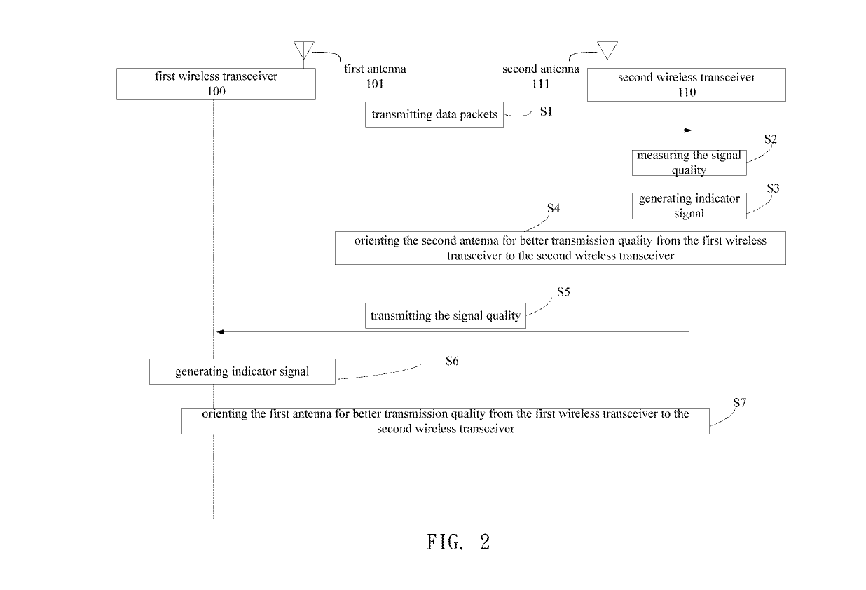

FIG. 2 is a flowchart showing how to carry out a (forward) transmission quality test in an antenna aligning system according to an exemplary embodiment of the disclosure. As shown in FIG. 2, in step S1, data packets are transmitted from the first antenna 101 of the first wireless transceiver 100 to the second wireless transceiver 110. The data packets may be a fixed-sized data file or a continuous, fixed-rate data stream. In step S2, the second wireless transceiver 110 measures the signal quality. In step S3, the second wireless transceiver 110 generates an indicator signal according to the signal quality. In step S4, the installer orients the second antenna for better transmission quality according to the indicator. In step S5, the second baseband transceiver 112 transmits the signal quality data back to the first wireless transceiver 100. The first baseband transceiver 102 receives the signal quality data by using the first antenna 101. The first processor 103 comprises the executable software that receives the transmission quality from the second antenna 111. In step S6, the indicator 104 of first wireless transceiver 100 generates the indicator signal according to the signal quality. In step S7, the indicator 104 of the first wireless transceiver 100 assists the installer how the antenna should be oriented.

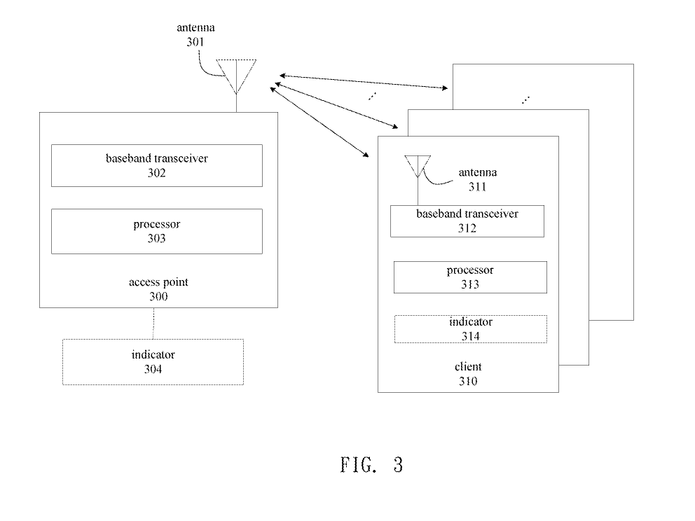

FIG. 3 shows an antenna aligning system according to another exemplary embodiment of the disclosure. This disclosure applies the aforementioned antenna aligning principle to a scenario where a wireless device (in a role of an Access Point or AP) is to provide radio services to multiple wireless devices (in the roles of clients to the AP). As shown in FIG. 3, the antenna system comprises a first wireless transceiver and a plurality of second wireless transceivers. The first wireless transceiver is an access point 300 and the plurality of second wireless transceivers are a plurality of clients 310. Both the access point 300 and the clients 310 include implicit function blocks such as frequency shifting, amplification, and modulation/demodulation baseband (not shown for clarity). The access point 300 comprises an antenna 301, a baseband transceiver 302, a processor 303, and an indicator 304. The clients 310 may be smart mobile devices that link to the same access point 300. Each of the clients 310 comprises an antenna 311, a baseband transceiver 312, a processor 313, and an indicator 314.

The processor 303 in the AP comprises executable software that generates the data packets. The data packets are transmitted by the baseband transceiver 302 and the antenna 301, and received by the antenna 311 and then the baseband transceiver 312. The processor 313 of the client 310 comprises executable software that measures the signal quality according to the completeness of the data packets received and the time spent. The indicator 314 of the client may be user interface of the smart mobile devices. User may adjust the orientation of the antenna 311 of the smart device according to the indicator signal, or adjust the antenna 311 by application software automatically. The signal quality data can further be transmitted back to the access point 300, to create a display on the indicator. The indication can either be from the embedded indicator 304 or from the client's user interface. The antenna orientation is adjusted according to the indicator signal to improve the signal quality from the access point 300 to the clients 310. Furthermore, the access point 300 may serve a plurality of clients 310 in the field. Each of the plurality of clients 310 is located at different locations with different radio transmission paths in differentiated obstructions, reflections and interferences to the access point 300. The processor 303 of the access point 300 can generate a composite indicator signal according to signal qualities from those clients 310, preferably weighted according to locations of the clients. The installer adjusts the direction of the antenna 301 according to the composite indicator signal. The plurality of clients in the same field thus may have the same level of signal quality or have differentiated signal qualities according to the importance of different locations.

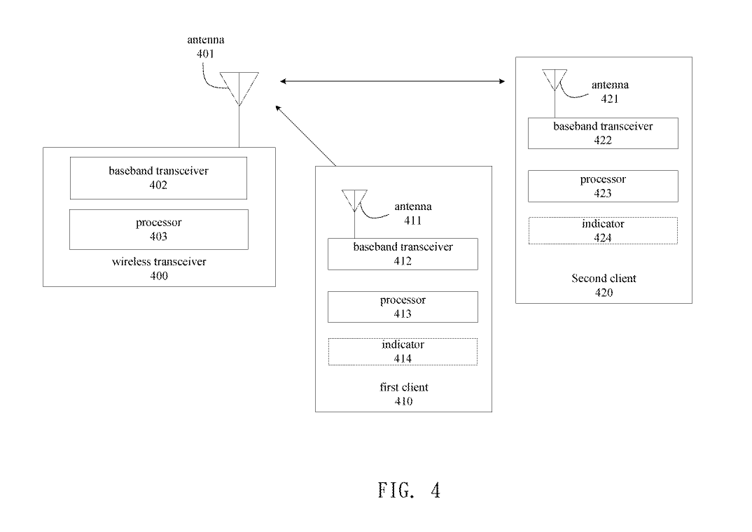

FIG. 4 shows an antenna aligning system according to an exemplary embodiment of the disclosure. Assume that one of client devices connected to the wireless transceiver 400 has the capability to generate the test data packets. Also assume that another client device has the capability to measure the signal quality according to the completeness of the received data packets and the time spent. In this case, the wireless transceiver 400 can further be simplified. As shown in FIG. 4, the antenna system comprises the wireless transceiver 400, a first client 410 and a second client 420. Both the wireless transceiver 400 and the second client 420 include implicit function blocks such as frequency shifting, amplification, and modulation/demodulation baseband (not shown for clarity). The first client 410 may be a wired or wireless device. The wireless transceiver 400 comprises an antenna 401, a baseband transceiver 402, and a processor 403. The first client 410 and the second client 420 may be smart mobile devices. The first client 410 comprises an antenna 411, a baseband transceiver 412, a processor 413, and an indicator 414. The second client 420 comprises an antenna 421, a baseband transceiver 422, a processor 423, and an indicator 424.

The first client 410 in intended to be located near the wireless transceiver 400. The first client 410 is used as an assistance tool to help the installer adjust the orientation of the antenna 401. The processor 413 of the first client 410 comprises executable software for generating data packets. The data packets are transmitted to the wireless transceiver 400 via the antenna 411, or a cable if the link to the wireless transceiver 400 is made wired (not shown in FIG. 4). The wireless transceiver 400 acts as a relay between the first client 410 and the second client 420. The wireless transceiver 400 transmits the received data packets to the second client 420. The processor 423 of the second client 420 comprises executable software that measures the signal quality according to the completeness of received data packets and the time spent. The indicator 424 of the second client is the user interface provided by the application of the smart mobile devices. The user may adjust the antenna 421 of the second client according to the indicator signal, or adjust the antenna 421 by an application automatically. The processor 413 can generates the indicator signals according to the signal quality feedback from the second client 420 via the wireless transceiver 400. Possibly being a smart mobile devices, the indicator 414 of the first client 410 acts as the installer's user interface. Since the first client 410 is nearby the wireless transceiver 400, the installer orients the antenna 401 according to the indicator signal provided by the indicator 414. The antenna direction is adjusted according to the indicator signal to improve the signal quality from the wireless transceiver 400 to the second clients 420. Since smart mobile devices are widely available, the wireless transceiver 400 just needs to connect to one smart mobile device nearby (such as the first client 410), to exempt the need of an embedded processor or executable software to generate the test data packets. The first client 410 takes over the role of a processor with executable software, simplifying the function of the wireless transceiver 400. The processor 403 of the wireless transceiver is only left with the function of relaying the data packets between the first client 410 and the second client 420.

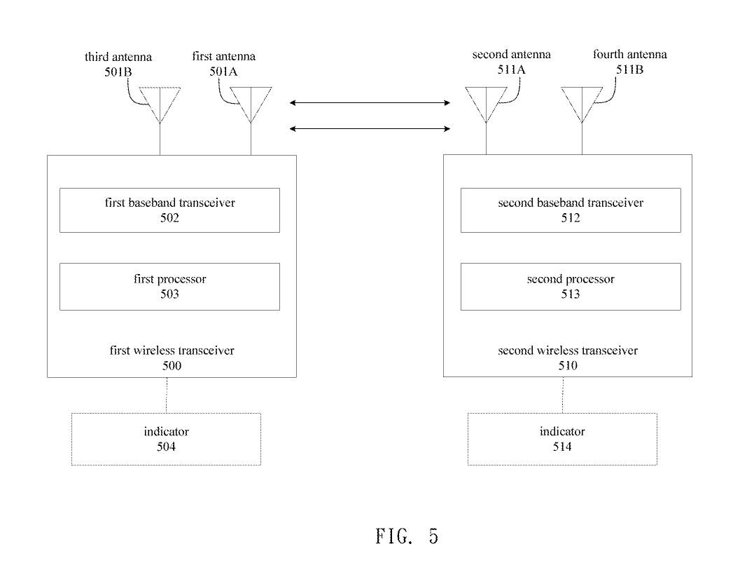

FIG. 5 shows a multiple antenna system according to an exemplary embodiment of the disclosure. The same principles as disclosed may also be used in a wireless device having multiple antennas (especially multi-input multi-output, MIMO, beam forming, or frequency multiplexing). As shown in FIG. 5, a multiple antenna system according to an exemplary embodiment of the disclosure comprises a first wireless transceiver 500 and a second wireless transceiver 510. The first wireless transceiver 500 comprises a first antenna 501A, a third antenna 501B, a first baseband transceiver 502, and a first processor 503. The second wireless transceiver 510 comprises a second antenna 511A, a fourth antenna 511B, a second baseband transceiver 512, and a second processor 513. The first wireless transceiver 500 may comprise an indicator 504, and the second wireless transceiver 510 may comprise an indicator 514.

The first wireless transceiver 500 uses the first antenna 501A and the third antenna 501B to communicate simultaneously with the second antenna 511A and the fourth antenna 511B of the second wireless transceiver 510, using MIMO or beam forming communication technology. The first antenna 501A or the third antenna 501B also may communicate singularly with the second antenna 511A or the fourth antenna 511B, in making use of the skills of beam forming or frequency multiplexing. The operation of MIMO, beam forming, or frequency multiplexing are being processed by the first processor 503 and the second processor 513, in an independent or coordinated effort. The first processor 503 comprises executable software to generate the data packets for MIMO, beam forming, or frequency multiplexing. The second processor 513 comprises executable software to assess the signal quality according to the completeness of receiving data packets and the time spent. The indicator 504 of the first wireless transceiver 500 assists the installer to find the optimal the orientations of the first antenna 501A and the third antenna 501B according to the signal quality, to improve the signal quality from the first wireless transceiver 500 to the second transceiver 510. Algorithms of MIMO or beam-forming antenna already have the capability of self-adjusting to the best bandwidth or the strongest signal in a complicated terrain with electromagnetic wave reflections. If the installer can pre-adjust the orientations of the antennas according to aforementioned procedure as general baseline antenna orientations, MIMO or beam-forming mechanism can further improve the coverage dynamically for time-varying environment changes. This way the optimizations are multiplied.

The exemplary embodiments shown and described above are only examples. Therefore, many such details of the art are neither shown nor described. Even though numerous characteristics and advantages of the technology have been set forth in the foregoing description, together with details of the structure and function of the disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An antenna aligning system, comprising:
a first wireless transceiver, comprising:
a first antenna;
a first processor generating data packets;
a first baseband transceiver transmitting or receiving wireless signals and transmitting the data packets; and
one or a plurality of second wireless transceivers, each comprising:
a second antenna;
a second baseband transceiver transmitting or receiving the wireless signal, and receiving the data packets;
a second processor measuring a signal quality according to the received data packets; and
the first antenna, the second antenna being oriented according to the signal quality.

2. The antenna aligning system as claimed in claim 1, wherein the first wireless transceiver comprises a third antenna, and the first antenna and the third antenna communicate with the second antenna at the same time.

3. The antenna aligning system as claimed in claim 2, wherein the second wireless transceiver comprises a fourth antenna; wherein the first antenna and the third antenna transmit and receive the electromagnetic waves to the second antenna and the fourth antenna with MIMO technology.

4. An antenna aligning system, comprising:
a wireless transceiver relaying data packets and signal qualities between a first client and a second client, and wireless transceiver communicating with the first client and the second client, wherein:
the first client generates the data packets to the second client through the wireless transceiver;
the second client measures the signal quality according to the received data packets;
the second client transmits the signal quality to the first client;
the first client generates the indicator signal according to the signal quality; and
the wireless transceiver orients of the antenna according to the indicator signal.

5. An antenna aligning method, comprising:
generating data packets through a first processor of a first wireless transceiver;
transmitting the data packets through a first antenna of the first wireless transceiver;
receiving the data packets through a second antenna of a second wireless transceiver;
measuring a signal quality according to the data packets;
generating an indicator signal according to the signal quality; and
orienting of the first antenna and the second antenna according to the indicator signal.

6. The antenna aligning method as claimed in claim 5, wherein orienting of the first antenna and the second antenna is dynamically corrected by a motor according to the signal quality.

7. The antenna aligning method as claim in claim 6, wherein the first antenna and the second antenna are not stationary.

8. An antenna aligning method, comprising:
generating data packets through a first processor of a first wireless transceiver;
transmitting the data packets through a first antenna of the first wireless transceiver;
receiving the data packets through a second antenna of a plurality of second wireless transceivers;
measuring signal qualities according to the received data packets;
the plurality of second wireless transceivers returns the signal qualities to the first wireless transceiver;
generating a composite indicator signal according to the signal qualities; and
orienting of the first antenna and the second antenna according to the indicator signal.
